(19) United States
(12) Patent Application Publication
(10) Pub. No.: US 2006/0175863 A1
(43) Pub. Date: Aug. 10, 2006

(54) Articulated hinge for vehicle bed covers and the like

(76) Inventor: Shirl L. Evans, Wooster, OH (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/351,825

(22) Filed: Feb. 9, 2006

Related U.S. Application Data
(60) Provisional application No. 60/653,347, filed on Feb. 9, 2005.

(51) Int. Cl. B60P 7/02

(52) U.S. Cl. 296/100.08

(57) ABSTRACT

An articulated hinge for mounting a cover to the open bed of a vehicle includes first and second arms pivotally interconnected at medial portions thereof in a scissors-like configuration. First and second links are pivotally connected to the rearward and forward ends, respectively, of the second arm. The forward end of the first arm and the outer end of the first link are pivotally connected to the cover in a longitudinally spaced apart relationship, and the rearward end of the first arm and the outer end of the second link are pivotally connected to the vehicle bed in a longitudinally spaced apart relationship, such that vertical translation of the rear of the cover shifts the same between open and closed positions. An adjustment mechanism is associated with the second link and varies the distance between the opposite pivot points on the second link while permitting pivotal motion about the same. Manipulation of the adjustment mechanism achieves substantially vertical translation of the cover as it shifts into and out of the closed position to facilitate sealing contact between the cover and the vehicle bed.

### CLAIM OF PRIORITY

Applicant hereby claims priority benefits under the provisional of 35 U.S.C. § 119, basing said claim of priority to Provisional Patent Application Ser. No. 60/653,347, filed Feb. 9, 2005.

### BACKGROUND OF THE INVENTION

The present invention relates to covers for open vehicle beds and the like, and in particular to an articulated hinge therefor.

Covers for open pickup truck beds and/or other similar vehicle cargo areas are well known in the art. Rigid or hard tonneau covers are typically mounted on an associated vehicle by hinges which permit the cover to be shifted between a generally horizontal closed position which encloses the vehicle bed, and an angled open position which permits access to the vehicle bed. While prior hinge designs have proven generally effective, certain drawbacks still exist.

One problem experienced with prior tonneau covers is obtaining a secure seal with the vehicle bed in the fully closed position. Many hinges cause the cover to close at a substantial angle to the vehicle bed, which makes it difficult to achieve a secure seal, particularly when the shape of the vehicle bed and/or cover is not precisely regular or rectangular.

Another drawback associated with prior tonneau covers is that they cannot be quickly and easily removed from the vehicle bed to permit the vehicle to haul large objects, such as household refrigerators, stoves, furniture and other bulky items. Hence, a hinge mechanism which permits the cover to be quickly and easily removed from the vehicle is clearly advantageous.

### SUMMARY OF THE INVENTION

One aspect of the present invention is a vehicle bed cover of the type shaped to selectively cover an open bed portion of an associated vehicle in combination with an articulated hinge which permits shifting the cover between a generally horizontal closed position which encloses the vehicle bed, and an angled open position which permits access to the vehicle bed. The articulated hinge includes a first elongate hinge arm having a forward end pivotally connected with the cover at a first pivot point, a rearward end configured for pivotal connection with the vehicle at a second pivot point, and a medial portion positioned intermediate the forward and rearward ends. The articulated hinge also includes a second elongate hinge arm having a forward end, an oppositely disposed rearward end, and a medial portion pivotally connected with the medial portion of the first hinge arm at a third pivot point. The hinge also includes a first link having a first end pivotally connected with the rearward end of the second hinge arm at a fourth pivot point, and a second end pivotally connected with the cover at a fifth pivot point which is spaced longitudinally a predetermined distance from the first pivot point, as well as a second link having a first end pivotally connected with the forward end of the second hinge arm at a sixth pivot point, and a second end thereof configured for pivotal connection with the vehicle at a seventh pivot point which is spaced longitudinally a predetermined distance from the second pivot point, whereby vertical translation of the rearward end of the cover shifts the cover between the open and closed positions. The articulated hinge also includes an adjustment mechanism associated with the second link, which varies the distance between the sixth and seventh pivot points while permitting pivotal motion about the same, whereby manipulation of the adjustment mechanism achieves substantially vertical translation of the cover as the same shifts into and out of the closed position to facilitate sealing contact between the cover and the vehicle.

Another aspect of the present invention is an articulated hinge for mounting a cover to an open bed portion of an associated vehicle. The hinge includes a first elongate hinge arm having a forward end configured for pivotally connection with the cover at a first pivot point, a rearward end configured for pivotal connection with the vehicle at a second pivot point, and a medial portion positioned intermediate the forward and rearward ends. The hinge also includes a second elongate hinge arm having a forward end, an oppositely disposed rearward end, and a medial portion pivotally connected with the medial portion of the first hinge arm at a third pivot point. The hinge also includes a first link having a first end pivotally connected with the rearward end of the second hinge arm at a fourth pivot point, and a second end configured for pivotal connection with the cover at a fifth pivot point which is spaced longitudinally a predetermined distance from the first pivot point, as well as a second link having a first end pivotally connected with the forward end of the second hinge arm at a sixth pivot point, and a second end configured for pivotal connection with the vehicle at a seventh pivot point which is spaced longitudinally a predetermined distance from the second pivot point, whereby vertical translation of the rearward end of the cover shifts the cover between a generally horizontal closed position which encloses the vehicle bed, and an angled open position which permits access to the vehicle bed. The hinge also includes an adjustment mechanism associated with the second link which varies the distance between the sixth and seventh pivot points while permitting pivotal motion about the same, whereby manipulation of the adjustment mechanism achieves substantially vertical translation of the cover as the same shifts into and out of the closed position to facilitate sealing contact between the cover and the vehicle.

Yet another aspect of the present invention is to provide an articulated hinge having an uncomplicated design that is efficient in use, economical to manufacture, capable of a long operating life, and particularly well adapted for the proposed use.

These and other advantages of the invention will be further understood and appreciated by those skilled in the art by reference to the following written specification, claims and appended drawings.

### BRIEF DESCRIPTION OF THE DRAWINGS

FIG. 1 is a perspective view of a pair of articulated hinges embodying the present invention, shown mounting a cover on a vehicle bed.

FIG. 2 is a side elevational view of one of the hinges, shown in an angled, fully open position to permit access to the vehicle bed.

FIG. 3 is a side elevational view of the hinge, shown in an intermediate position, with broken lines illustrating the path of translation of the cover.

FIG. 4 is a side elevational view of the hinge, shown in a slightly angled, nearly closed position.

FIG. 5 is a side elevational view of the hinge, shown in a generally horizontal, fully closed position, which encloses the vehicle bed.

FIG. 6 is a top plan view of a first hinge arm portion of the hinge.

FIG. 7 is a front elevational view of the first hinge arm.

FIG. 8 is a top plan view of a second hinge arm portion of the hinge.

FIG. 9 is a front elevational view of the second hinge arm.

FIG. 10 is a top plan view of a first link portion of the hinge.

FIG. 11 is a front elevational view of the first link.

FIG. 12 is a top plan view of a second link portion of the hinge.

FIG. 13 is a front elevational view of the second link.

FIG. 14 is an exploded perspective view of the hinge.

FIG. 15 is a perspective view of the hinge, shown in the fully open position.

### DETAILED DESCRIPTION OF THE PREFERRED EMBODIMENTS

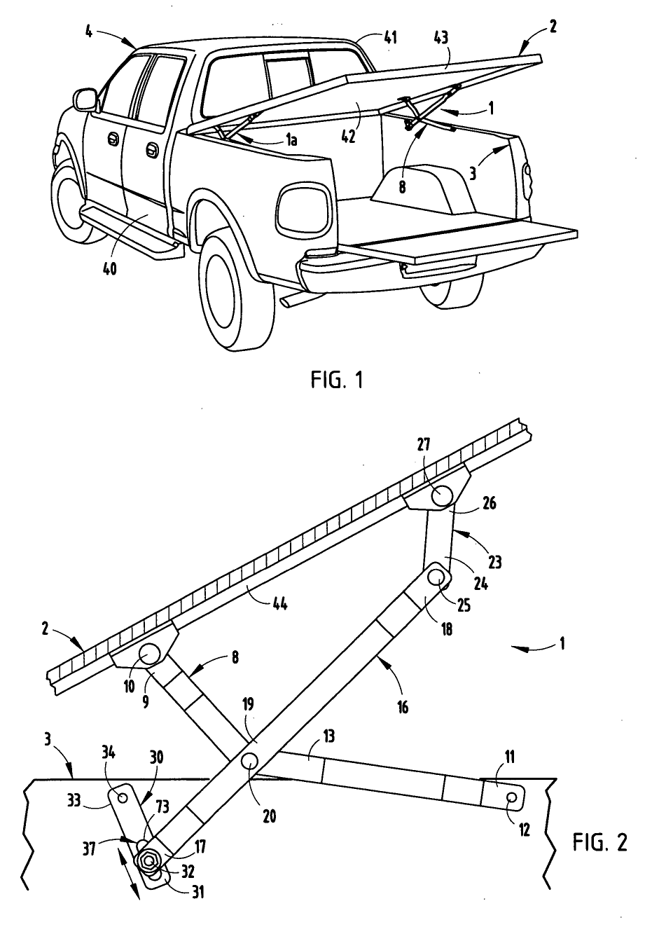

For purposes of description herein the terms “upper”, “lower”, “right”, “left”, “rear”, “front”, “vertical”, “horizontal” and derivatives thereof shall relate to the invention as oriented in FIG. 1, and installed in an associated vehicle. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The reference numeral 1 (FIG. 1) generally designates an articulated hinge embodying the present invention, which in the illustrated example, is specifically designed for mounting a hard tonneau cover 2 to the bed 3 of an associated pickup truck 4, so as to permit cover 2 to be shifted between a generally horizontal closed position which encloses vehicle bed 3 (FIG. 5), and an angled open position which permits access to vehicle bed 3 (FIGS. 1 and 2). Hinge 1 includes a first elongate hinge arm 8 having a forward end 9 pivotally connected with cover 2 at a first pivot point 10, a rearward end 11 pivotally connected with the bed 3 of pickup truck 4 at a second pivot point 12, and a medial portion 13 positioned intermediate of forward and rearward ends 9 and 11, respectively. Hinge 1 also includes a second elongate hinge arm 16 having a forward end 17, an oppositely disposed rearward end 18, and a medial portion 19 pivotally connected with the medial portion 13 of first hinge arm 8 at a third pivot point 20. A first link 23 has a first end 24 pivotally connected with the rearward end 18 of second hinge arm 16 at a fourth pivot point 25, and a second end 26 pivotally connected with cover 2 at a fifth pivot point 27 which is spaced longitudinally a predetermined distance from first pivot point 10. Hinge 1 also includes a second link 30 having a first end 31 pivotally connected with the forward end 17 of second hinge arm 16 at a sixth pivot point 32, and a second end 33 pivotally connected with the bed 3 of pickup truck 4 at a seventh pivot point 34 which is spaced longitudinally a predetermined distance from the second pivot point 12, such that vertical translation of the rearward end of cover 2 shifts the cover between the open and closed positions. Hinge 1 also includes an adjustment mechanism 37 associated with the second link 30, which varies the distance between the sixth and seventh pivot points 32 and 34, respectively, while permitting pivotal motion about the same, such that manipulation of adjustment mechanism 37 achieves substantially vertical translation of cover 2 as the same shifts into and out of the fully closed position to facilitate sealing contact between cover 2 and the bed 3 of pickup truck 4.

In the example illustrated in FIG. 1, a pair of substantially identical articulated hinges 1 and 1a are shown attaching cover 2 to the bed 3 of pickup truck 4. Hinges 1a is attached to the driver or street side 40 of the vehicle 4, while the opposite hinge 1 is attached to the passenger or curb side 41 of the vehicle 4. Both hinges have a substantially identical construction, and operate in a similar fashion, except that the ends 9, 11, 17 and 18 of the hinge arms 8 and 16 are offset laterally in opposite directions to position associated mounting brackets at similar locations on the cover 2, as described below in greater detail.

The illustrated lid or cover 2 is a hard tonneau cover having a generally conventional construction with a forward end 42 to which hinges 1 and 1a are attached, a rearward end 43 adapted for grasping to shift the same generally vertically between the open and closed positions, and a seal 44 positioned on the lower surface of cover 2 about the interior perimeter of the same to abut with the upper portion of vehicle bed 3, and form a seal therebetween.

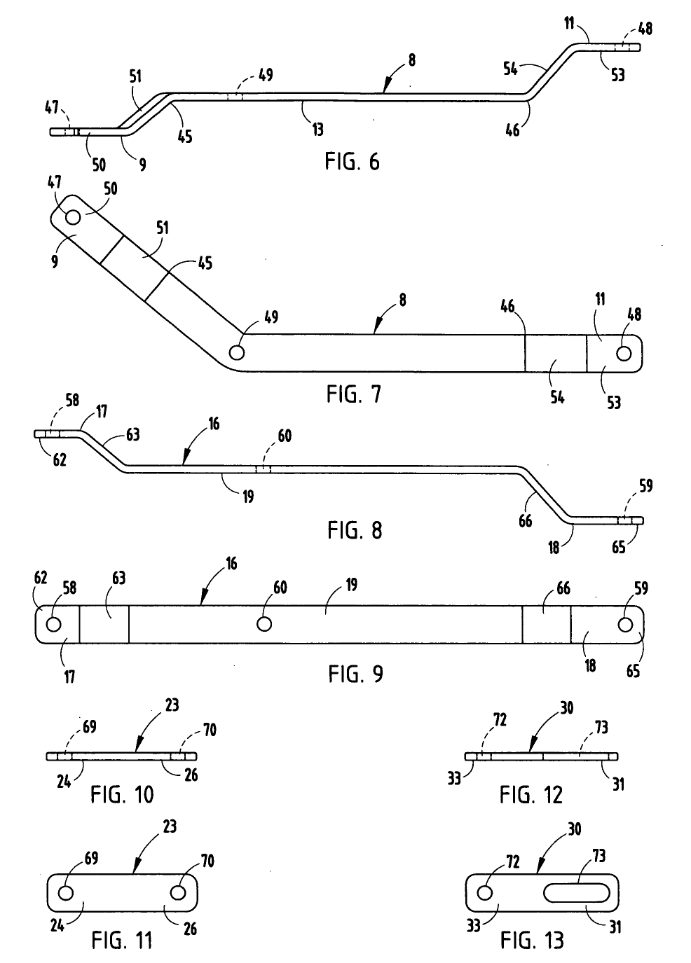

With reference to FIGS. 6 and 7, in the curb side hinge 1, the illustrated first hinge arm 8 is a rigid, formed elongate strap or bar having a generally L-shaped side elevational configuration, as shown in FIG. 7, a forward leg 45 associated with forward end 9, and a rearward leg 46 associated with rearward end 11. In the illustrated example, the forward leg 45 of first hinge arm 8 is oriented at an included angle in the range of 130 degrees to 150 degrees relative to the rearward leg 46 of first hinge arm 8. First hinge arm 8 also includes a first laterally extending aperture 47 disposed through the forward end 9 of first hinge arm 8 and defining a portion of first pivot point 10, a second horizontally extending aperture 48 disposed through the rearward end 11 of first hinge arm 8 and defining a portion of second pivot point 12, and a third horizontally extending aperture 49 disposed through the medial portion 13 of first hinge arm 8 and defining a portion of third pivot point 20. The medial portion 13 of first hinge arm 8 is generally flat and straight. As best illustrated in FIG. 6, the forward end 9 of first hinge arm 8 is laterally offset in an inwardly direction from the medial portion 13 of first hinge arm 8. More specifically, the forward end 9 of first hinge arm 8 includes a straight, flat portion 50 through which aperture 47 extends, oriented parallel with medial portion 13, and an angled portion 51 which extends at an angle between flat portion 50 and medial portion 13 of first hinge arm 8. The rearward end 11 of first hinge arm 8 is laterally offset in an outwardly direction from the medial portion 13 of first hinge arm 8. More specifically, the rearward end 11 of first hinge arm 8 includes a flat portion 53 through which aperture 48 extends, oriented parallel with medial portion 13, and an angled portion 54 extending at an angle between flat portion 53 and medial portion 13.

In one working embodiment of the present invention, first hinge arm 8 has a thickness of around 0.25 inch, a width of around 1.0 inch, an overall length of approximately 15.0 to 16.0 inches, and the forward and rearward legs 45 and 46 are oriented at an angle of around 140 degrees, with the distance between apertures 48 and 49 being around 10.0 to 10.5 inches, and the distance between apertures 47 and 49 being around 5.5 to 5.75 inches. Both the forward portion 50 and rearward portion 53 of the subject first hinge arm 8 are laterally offset a distance of around 1.25 inches.

With reference to FIGS. 8 and 9, in the curb side hinge 1, the illustrated second hinge arm 16 is a rigid, formed strap or bar having a generally straight or linear front elevational configuration, as shown in FIG. 9. Second hinge arm 16 has a first laterally extending aperture 58 positioned through the forward end 17 of second hinge arm 16 and defining a portion of sixth pivot point 32, a second laterally extending aperture 59 positioned through the rearward end 18 of second hinge arm 16 and defining a portion of fourth pivot point 25, and a third through aperture 60 extending through the medial portion 19 of second hinge arm 16 and defining a portion of the third pivot point 20. The forward end 17 of second hinge arm 16 is laterally offset in an outwardly direction from the medial portion 19 of second hinge arm 16. More specifically, the forward end 17 of second hinge arm 16 includes a flat portion 62 through which aperture 58 extends, oriented generally parallel with the medial portion 19 of second hinge arm 16, and an angled portion 63 which extends at an angle between flat portion 62 and the medial portion 19 of second hinge arm 16. The rearward end 18 of second hinge arm 16 is laterally offset in an inwardly direction from the medial portion 19 of second hinge arm 16. More specifically, the rearward end 18 of second hinge arm 16 includes a flat portion 65 through which aperture 59 extends, oriented generally parallel with the medial portion 19 of second hinge arm 16, and an angled portion 66 which extends at an angle between flat portion 65 and medial portion 19.

In one working embodiment of the present invention, second hinge arm 16 has a thickness of around 0.25 inch, a width of around 1.0 inch, and an overall length in the range of 16.0 to 16.5 inches, wherein the distance between through apertures 59 and 60 is around 10.0 inches, and the distance between through apertures 58 and 60 is around 5.5 to 5.75 inches. The length of the associated medial portion 19 is around 10.5 inches, and the forward and rearward end portions 62 and 65 are offset an amount in the range of 0.75 to 1.0 inch.

As best illustrated in FIGS. 10 and 11, the illustrated first link 23 is a rigid flat plate, having a generally rectangular front elevational shape, as shown in FIG. 11, and a straight or linear plan configuration, as shown in FIG. 10. The illustrated first link 23 has a first lateral through aperture 69 extending through the first end 24 thereof and defining a portion of fourth pivot point 25, and second lateral through aperture 70 extending through second end 26 and defining a portion of fifth pivot point 27.

In one working embodiment of the present invention, first link 23 has an overall length of approximately 4.0 inches, wherein the distance between through apertures 69 and 70 is around 3.0 inches. The subject first link has a thickness of around 0.25 inch, and a width of around 1.0 inch.

As best illustrated in FIGS. 12 and 13, the illustrated second link 30 is a rigid flat plate having a generally rectangular front elevational configuration, as shown in FIG. 13, and a straight or linear plan configuration, as shown in FIG. 12. The illustrated second link 30 has a laterally extending aperture 72 positioned through the second end 33 and defining a portion of seventh pivot point 34, and an elongate slot 73 positioned through the first end 31 and forming a portion of both the sixth pivot point 32 and the adjustment mechanism 37, as described in greater detail hereinafter.

In one working embodiment of the present invention, second link 30 has an overall length of approximately 4.25 inches, wherein the distance between aperture 72 and the longitudinal center of slot 73 is around 3.0 inches. The subject second link has a thickness of around 0.25 inch, and a width of around 1.0 inch. The length of the subject slot is around 1.25 inches.

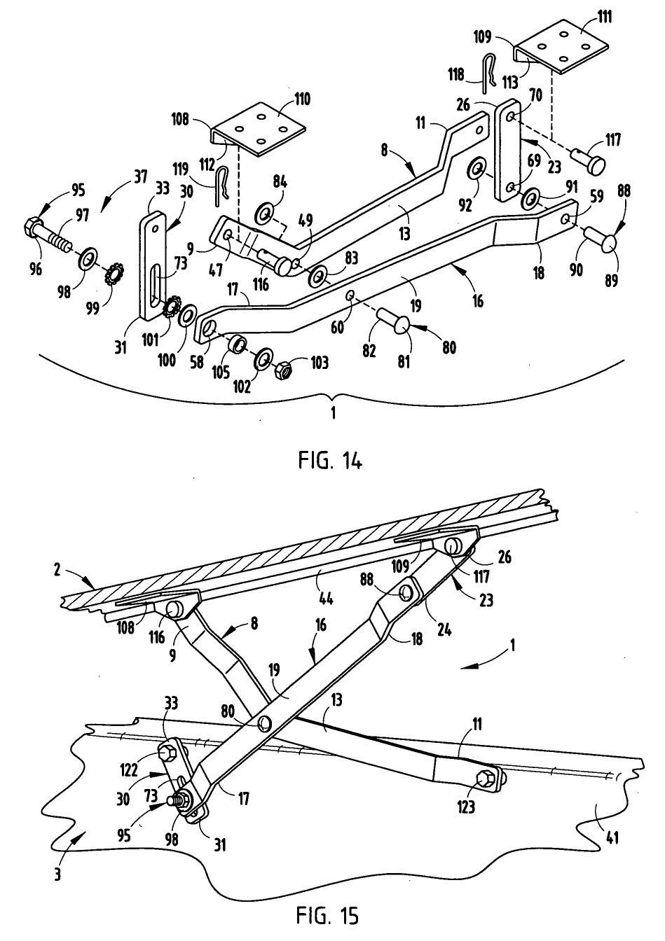

With reference to FIG. 14, the arms 8, 16 and links 23, 30 of hinge 1 are interconnected in the following manner. With the arms 8, 16 and links 23, 30 positioned in the fashion illustrated in FIG. 14, a first rivet 80 having a head portion 81 and a shank portion 82 is inserted through the aperture 60 in the medial portion 19 of second hinge arm 16, and the aperture 49 in the medial portion 13 of first hinge arm 8 to interconnect hinge arms 8 and 16 in a scissors-like fashion. A first flat washer 83 is mounted on the shank 82 of rivet 80 between hinge arms 8 and 16 to facilitate pivotal motion therebetween. A second flat washer 84 is positioned on the free end of the shank portion 82 of rivet 80, and after assembly, is captured thereon between the overturned free end of rivet shank 82 and the exterior face of first hinge arm 8 to facilitate rotational motion between hinge arms 8 and 16.

The first link 23 is attached to the rearward end 18 of second hinge arm 16 in a similar fashion. A rivet 88 having a head portion 89 and a shank portion 90 is inserted through the aperture 59 at the rearward end 18 of second hinge arm 16, and the aperture 69 in the first end 24 of first link 23. A first flat washer 91 is positioned on the shank 90 of rivet 88 between second hinge arm 16 and first link 23, and a second flat washer 92 is positioned over the free end of the shank portion 90 of rivet 88, and after assembly, is captured thereon between the overturned free end of rivet 88 and the exterior surface of first link 23 to facilitate rotational motion between hinge arm 16 and link 23.

The second link 30 is adjustably attached to the forward end 17 of second hinge arm 16 in the following manner. An annularly-shaped bushing 105 is positioned in the aperture 58 at the forward end 17 of second hinge arm 16. A bolt 95 having a head portion 96 and threaded shank portion 97 is inserted through the slot 73 at the second end 33 of second link 30 and through the bushing 105 at the forward end 17 of second hinge arm 16. A first flat washer 98 is assembled on the shank portion 97 of bolt 95 adjacent head 96, and a first lock washer 99 is positioned on the shank portion 97 of bolt 95 adjacent flat washer 98. Flat washer 98 and lock washer 99 are captured between the head portion 96 of bolt 95 and the exterior surface of second link 30. A second flat washer 100 and second lock washer 101 are positioned on the shank portion 97 of bolt 95 between second link 30 and second hinge arm 16. More specifically, lock washer 101 is positioned between second link 30 and flat washer 100, and flat washer 100 is positioned between lock washer 101 and the forward end 17 of second hinge arm 16. A third flat washer 102 is positioned over the free end of bolt 95, and a threaded nut 103 is engaged on the free end of bolt 95 to capture flat washer 102 between nut 103 and the interior surface of second hinge arm 16. The tightening of nut 103 on bolt 95 securely locks bolt 95 in a selected position within the slot 73 on second link 30, yet bushing 105 permits the second link 30 to rotate freely relative to second hinge arm 16 at the selected pivot point 32.

It is to be understood that first link 23 may be equipped with an adjustment mechanism 37 similar to that associated with second link 30, so as to provide even greater adjustability to hinges 1 and la, and the associated mounting of cover 2 to vehicle bed 3.

As best illustrated in FIG. 14, a pair of L-shaped mounting brackets 108 and 109 are provided to pivotally attach cover 2 to the forward end 9 of first hinge arm 8, and the outer end 26 of first link 23, respectively, in a longitudinally spaced apart relationship. More specifically, the upper, horizontally oriented legs 110 and 111 of mounting brackets 108 and 109 are attached to the lower surface of cover 2 using conventional fasteners, such as screws or the like (not shown). In one working embodiment of the present invention, mounting brackets 108 and 109 are spaced laterally apart a distance of around 14.0 inches. The vertical legs 112 and 113 of mounting brackets 108 and 109 include horizontally extending apertures through which retaining pins 116 and 117 are received. More specifically, with reference to FIGS. 14 and 15, retaining pin 117 is inserted through the aperture of mounting bracket 109, and the aperture 70 at the second end of second link 23 to form the fifth pivot point 27. A keeper pin 118 is inserted through a mating, radially extending aperture adjacent the free end of retaining pin 117 to securely, yet removably, keep retaining pin 116 in place. Similarly, retaining pin 116 is inserted through the aperture in mounting bracket 108, and then through the aperture 47 at the forward end of first hinge arm 8 to form the first pivot point 10. A keeper pin 119 is inserted through a mating, radially extending aperture adjacent the end of retaining pin 117 to securely, yet removably, keep retaining pin 117 in place.

With reference to FIG. 15, a pair of bolts 122 and 123 are used to detachably mount the illustrated hinge 1 to the bed 3 of vehicle 4. More specifically, bolt 122 is inserted through aperture 72 in second link 30 and anchored in vehicle bed 3 to define the seventh pivot point 34. Bolt 123 is inserted through aperture 48 in the first hinge arm 8 and anchored in the vehicle bed 3 to define a second pivot point 12. In the illustrated example, bolts 122 and 123 are positioned at a similar height on vehicle bed 3, and spaced longitudinally apart a distance of around 15.75 inches.

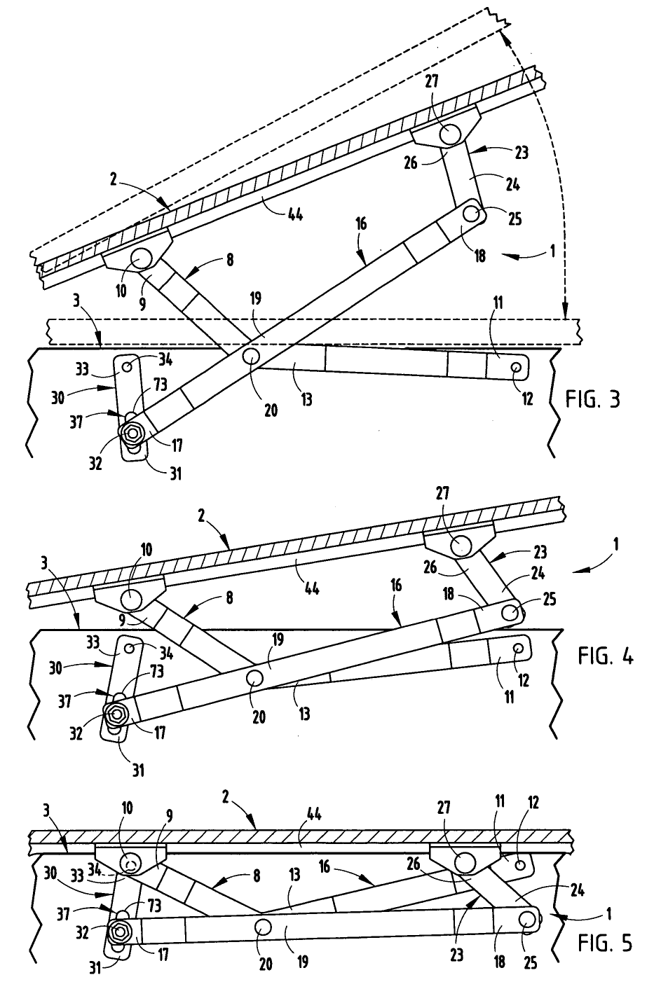

Once a pair of hinges 1 and 1a are installed between cover 2 and vehicle bed 3, cover 2 articulates in the following manner. When cover 2 is in the angled, fully open position illustrated in FIGS. 1 and 2, hinge arms 8 and 16 are rotated apart about pivot point 20, first link 23 is generally aligned along second hinge arm 16, and second link 30 is pivoted in a rearwardly direction, so as to assume a generally right angular relationship with second hinge arm 16. As cover 2 is rotated downwardly in the manner illustrated in FIGS. 3 and 4, hinge arms 8 and 16 pivotally close together, first link 23 rotates in a counterclockwise fashion about fifth pivot point 27 to assume a generally right angular relationship with second hinge arm 16, and second link 30 rotates in a clockwise direction about seventh pivot point 34 to a generally vertical orientation. The location of the sixth pivot point 32 relative to the seventh pivot point 34 is adjusted by manipulation of adjustment mechanism 37, so that hinges 1 and 1a achieve substantially vertical translation of cover 2 as the same shifts into and out of the fully closed position, thereby facilitating sealing contact between the seal 44 on cover 2 and the bed portion 3 of vehicle 4. More specifically, the position of the sixth pivot point 32 is adjusted by loosening the nut 103 on bolt 95 and shifting the forward end 17 of second hinge arm 16 toward and away from the seventh pivot point 34, which causes the shank portion 97 of bolt 95 to move longitudinally along slot 73 in link 30. Once the proper position has been selected to achieve a good fit between the seal 44 on cover 2 and the vehicle bed 3, nut 103 is then tightened to maintain link 30 and hinge arm 16 in the selected position. The shifting of the sixth pivot point 32 relative to the seventh pivot point 34 by manipulation of adjustment mechanism 37 also varies the vertical lift between cover 2 and vehicle bed 3 at the forward end 42 of cover 2, so as to provide more convenient access to the forward portion of vehicle bed 3.

The laterally offset portions of hinge arms 8 and 16 extend in opposite directions, as shown in FIG. 15, to create a gap or space between hinge arms 8 and 16 in which a clamp, prop or other similar device (not shown) can be installed in the area between pivot points 12 and 34 to retain cover 2 at a selected position relative to vehicle bed 3. The laterally offset configuration of arms 8 and 16 also serves to stiffen or rigidify hinges 1 and 1a in a horizontal direction. In one working embodiment of the present invention, this lateral offset is around 3.0 to 4.0 inches wide. In the subject working embodiment, pivot points 10, 12, 20, 25, 27, 32 and 34 are preferably arranged so that when cover 2 is in the fully closed position, both links 23 and 30 are angled slightly rearwardly toward the rearward end 43 of cover 2 to alleviate binding between hinge arms 8 and 16 and links 23 and 30.

Cover 2 can be easily and quickly removed from the bed 3 of vehicle 4 in the following manner. Keeper pins 118 and 119 are first removed, and retainer pins 116 and 117 are then slid horizontally inwardly, thereby releasing the pivotal connection between mounting brackets 108 and 109, and their associated hinges 1 and 1a. Cover 2 can then be removed from vehicle bed 3, and hinges 1 and 1a can be folded downwardly to an out of the way location.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is as follows:

1. In a vehicle bed cover of the type shaped to selectively cover an open bed portion of an associated vehicle, the improvement of an articulated hinge which permits shifting said cover between a generally horizontal closed position which encloses the vehicle bed, and an angled open position which permits access to the vehicle bed, comprising:
a first elongate hinge arm having a forward end thereof pivotally connected with said cover at a first pivot point, a rearward end thereof configured for pivotal connection with the vehicle at a second pivot point, and a medial portion thereof positioned intermediate of said forward and rearward ends;
a second elongate hinge arm having a forward end thereof, an oppositely disposed rearward end thereof, and a medial portion thereof pivotally connected with said medial portion of said first hinge arm at a third pivot point;
a first link having a first end thereof pivotally connected with said rearward end of said second hinge arm at a fourth pivot point, and a second end thereof pivotally connected with said cover at a fifth pivot point which is spaced longitudinally a predetermined distance from said first pivot point;
a second link having a first end thereof pivotally connected with said forward end of said second hinge arm at a sixth pivot point, and a second end thereof configured for pivotal connection with said vehicle at a seventh pivot point which is spaced longitudinally a predetermined distance from said second pivot point, whereby vertical translation of a rearward end of said cover shifts said cover between said open and closed positions; and
an adjustment mechanism associated with said second link and varying the distance between said sixth and seventh pivot points while permitting pivotal motion about said sixth and seventh pivot points, whereby manipulation of said adjustment mechanism achieves substantially vertical translation of said cover as the same shifts into and out of said closed position to facilitate sealing contact between said cover and the vehicle.

2. A vehicle bed cover as set forth in claim 1, wherein:
said adjustment mechanism comprises a slot through said first end of said second link with a central longitudinal axis disposed in alignment with said sixth pivot point, and a fastener extending through said slot and said forward end of said second hinge arm with a lock nut tightened on the free end of said fastener to releasably, yet securely, locate said fastener at a selected location along said slot, yet permit pivotal motion between said second link and said second hinge arm about said sixth pivot point.

3. A vehicle bed cover as set forth in claim 2, wherein:
said fastener comprises a bolt having a head and a threaded shank.

4. A vehicle bed cover as set forth in claim 3, including:
a bushing rotatably mounted in said forward end of said second hinge arm, and receiving said bolt therethrough;
a first lock washer disposed on said shank of said bolt between said head and an exterior surface of said first link; and
a second lock washer disposed on said shank of said bolt between an interior surface of said first link and an exterior surface of said forward end of said second hinge arm.

5. A vehicle bed cover as set forth in claim 4, including:
a first flat washer disposed on said shank of said bolt between said head of said bolt and said first lock washer; and
a second flat washer disposed on said shank of said bolt between said lock nut and said forward end of the second hinge arm.

6. A vehicle bed cover as set forth in claim 5, wherein:
said rearward end of said first hinge arm is laterally offset in an outwardly direction from said medial portion of said first hinge arm; and
said forward end of said first hinge arm is laterally offset in an inwardly direction from said medial portion of said first hinge arm.

7. A vehicle bed cover as set forth in claim 6, wherein:
said rearward end of said second hinge arm is laterally offset in an inwardly direction from said medial portion of said second hinge arm; and
said forward end of said second hinge arm is laterally offset in an outwardly direction from said medial portion of said second hinge arm.

8. A vehicle bed cover as set forth in claim 7, wherein:
said rearward end of said first hinge arm and said second link are aligned in a common vertical plane.

9. A vehicle bed cover as set forth in claim 8, wherein:
said forward end of said first hinge arm and said first link are aligned in a common vertical plane.

10. A vehicle bed cover as set forth in claim 9, wherein:
said second hinge arm has a substantially straight linear side elevational configuration in an installed condition.

11. A vehicle bed cover as set forth in claim 10, wherein:
said first hinge arm has a generally L-shaped side elevational configuration in an installed condition.

12. A vehicle bed cover as set forth in claim 11, wherein:
said first hinge arm includes a forward portion associated with said forward end thereof, and a rearward portion associated with said rearward end thereof; and wherein said forward portion of said first hinge arm is oriented at an included angle in the range of 130 degrees to 150 degrees relative to said rearward portion of said first hinge arm.

13. A vehicle bed cover as set forth in claim 12, wherein:
said forward end of said first hinge arm includes a horizontally extending mounting aperture therethrough defining a portion of said first pivot point; and
said second end of said second link includes a horizontally extending mounting aperture therethrough defining a portion of said fifth pivot point.

14. A vehicle bed cover as set forth in claim 13, including:
a first mounting bracket shaped for attachment with said cover at a location adjacent to said first pivot point, and including a first horizontally extending mounting pin closely received in said mounting aperture in said forward end of said first hinge arm to pivotally support the same thereon at said first pivot point, and a first detachable retainer connected with a free end of said first mounting pin; and
a second mounting bracket shaped for attachment with said cover at a location adjacent to said fifth pivot point, and including a second horizontally extending mounting pin closely received in said mounting aperture in said second end of said first link to pivotally support the same thereon at said fifth pivot point, and a second detachable retainer connected with a free end of said second mounting pin, whereby detachment of said first and second retainers from said first and second mounting pins permits quick and easy removal of said cover from the vehicle bed.

15. An articulated hinge for mounting a cover to an open bed portion of an associated vehicle, comprising:
a first elongate hinge arm having a forward end thereof configured for pivotal connection with the cover at a first pivot point, a rearward end thereof configured for pivotal connection with the vehicle at a second pivot point, and a medial portion thereof positioned intermediate of said forward and rearward ends;
a second elongate hinge arm having a forward end thereof, an oppositely disposed rearward end thereof, and a medial portion thereof pivotally connected with said medial portion of said first hinge arm at a third pivot point;
a first link having a first end thereof pivotally connected with said rearward end of said second hinge arm at a fourth pivot point, and a second end thereof configured for pivotal connection with the cover at a fifth pivot point which is spaced longitudinally a predetermined distance from said first pivot point;
a second link having a first end thereof pivotally connected with said forward end of said second hinge arm at a sixth pivot point, and a second end thereof configured for pivotal connection with said vehicle at a seventh pivot point which is spaced longitudinally a predetermined distance from said second pivot point, whereby vertical translation of a rearward end of said cover shifts said cover between a generally horizontal closed position which encloses the vehicle bed, and an angled open position which permits access to the vehicle bed; and
an adjustment mechanism associated with said second link and varying the distance between said sixth and seventh pivot points while permitting pivotal motion about said sixth and seventh pivot points, whereby manipulation of said adjustment mechanism achieves substantially vertical translation of the cover as the same shifts into and out of said closed position to facilitate sealing contact between the cover and the vehicle.

16. A vehicle bed cover as set forth in claim 15, wherein:
said adjustment mechanism comprises a slot through said first end of said second link with a central longitudinal axis disposed in alignment with said sixth pivot point, and a fastener extending through said slot and said forward end of said second hinge arm with a lock nut tightened on the free end of said fastener to releasably, yet securely, locate said fastener at a selected location along said slot, yet permit pivotal motion between said second link and said second hinge arm about said sixth pivot point.

17. A vehicle bed cover as set forth in claim 16, wherein:
said fastener comprises a bolt having a head and a threaded shank.

18. A vehicle bed cover as set forth in claim 17, including:
a bushing rotatably mounted in said forward end of said second hinge arm, and receiving said bolt therethrough;
a first lock washer disposed on said shank of said bolt between said head and an exterior surface of said first link; and
a second lock washer disposed on said shank of said bolt between an interior surface of said first link and an exterior surface of said forward end of said second hinge arm.

19. A vehicle bed cover as set forth in claim 18, including:
a first flat washer disposed on said shank of said bolt between said head of said bolt and said first lock washer; and
a second flat washer disposed on said shank of said bolt between said lock nut and said forward end of the second hinge arm.

20. A vehicle bed cover as set forth in claim 19, wherein:
said rearward end of said first hinge arm is laterally offset in an outwardly direction from said medial portion of said first hinge arm; and
said forward end of said first hinge arm is laterally offset in an inwardly direction from said medial portion of said first hinge arm.

21. A vehicle bed cover as set forth in claim 20, wherein:
said rearward end of said second hinge arm is laterally offset in an inwardly direction from said medial portion of said second hinge arm; and
said forward end of said second hinge arm is laterally offset in an outwardly direction from said medial portion of said second hinge arm.

22. A vehicle bed cover as set forth in claim 21, wherein:
said rearward end of said first hinge arm and said second link are aligned in a common vertical plane.

23. A vehicle bed cover as set forth in claim 22, wherein:
said forward end of said first hinge arm and said first link are aligned in a common vertical plane.

24. A vehicle bed cover as set forth in claim 23, wherein:
said second hinge arm has a substantially straight linear side elevational configuration in an installed condition.

25. A vehicle bed cover as set forth in claim 24, wherein:
said first hinge arm has a generally L-shaped side elevational configuration in an installed condition.

26. A vehicle bed cover as set forth in claim 25, wherein:
said first hinge arm includes a forward portion associated with said forward end thereof, and a rearward portion associated with said rearward end thereof; and wherein said forward portion of said first hinge arm is oriented at an included angle in the range of 130 degrees to 150 degrees relative to said rearward portion of said first hinge arm.

27. A vehicle bed cover as set forth in claim 26, wherein:
said forward end of said first hinge arm includes a horizontally extending mounting aperture therethrough defining a portion of said first pivot point; and
said second end of said second link includes a horizontally extending mounting aperture therethrough defining a portion of said fifth pivot point.

28. A vehicle bed cover as set forth in claim 27, including:
a first mounting bracket shaped for attachment with the cover at a location adjacent to said first pivot point, and including a first horizontally extending mounting pin closely received in said mounting aperture in said forward end of said first hinge arm to pivotally support the same thereon at said first pivot point, and a first detachable retainer connected with a free end of said first mounting pin; and
a second mounting bracket shaped for attachment with the cover at a location adjacent to said fifth pivot point, and including a second horizontally extending mounting pin closely received in said mounting aperture in said second end of said first link to pivotally support the same thereon at said fifth pivot point, and a second detachable retainer connected with a free end of said second mounting pin, whereby detachment of said first and second retainers from said first and second mounting pins permits quick and easy removal of the cover from the vehicle bed.
